(19) United States
(12) Patent Application Publication
(10) Pub. No.: US 2018/0081483 A1
(43) Pub. Date: Mar. 22, 2018

(54) TRACKPAD INTEGRATION IN AN ELECTRONIC DEVICE

(71) Applicant: Apple Inc., Cupertino, CA (US)

(72) Inventors: John S. Camp, Cupertino, CA (US); Scott J. McEuen, Cupertino, CA (US); Qiliang Xu, Cupertino, CA (US)

(21) Appl. No.: 15/267,221

(22) Filed: Sep. 16, 2016

(51) Int. Cl. G06F 3/041; G06F 3/044; G06F 3/0354; G06F 3/01

(52) U.S. Cl. CPC G06F 3/0416; G06F 3/044; G06F 3/03547; G06F 2203/04104; G06F 2203/04105; G06F 2203/04103; G06F 3/016

(57) ABSTRACT

A trackpad includes an interface module positioned below a cover layer. The interface module can include a support structure and a circuit board attached to the support structure. The support structure includes suspension elements that allow the cover layer to move vertically and/or horizontally. The circuit board can include one or more force sensors, touch sensors, and/or haptic output devices. In some embodiments, the one or more touch sensors are included in a separate touch-sensitive layer positioned between the cover layer and the interface module. Alternatively, an interface module can include a suspension element positioned below a circuit board.

### FIELD

The described embodiments relate generally to electronic devices. More particularly, the present embodiments relate to techniques and systems for integrating a trackpad in an enclosure of an electronic device.

### BACKGROUND

Electronic devices can receive user inputs from a variety of different types of input devices, such as a keyboard, a button, a trackpad, and a display. Some of these input devices include various components for sensing, performing electronic functions, and providing mechanical or structural support. Integrating all of these components into a small space or thin device may present a significant challenge and, in some cases, may be cost prohibitive. The present disclosure is directed to systems and techniques for integrating components of a trackpad into an electronic device without some of the drawbacks associated with some traditional approaches.

### SUMMARY

In one aspect, an electronic device includes one or more input devices. One example of an input device is a trackpad. The trackpad can include an input surface or cover layer, an input/output or circuit board positioned below the cover layer, and a support structure positioned below the circuit board. The support structure is formed in a recessed section of the housing such that the support structure and the housing (e.g., a top surface or case of the housing) are a monolithic and/or unitary structure that is formed in a single operation (e.g., at the same time with the same material(s)). The cover layer is configured to receive touch and force inputs. The support structure includes suspension elements that are configured to permit movement along one or multiple axes (e.g., first and second axes). For example, the cover layer can be displaced (e.g., move up and down) and shift laterally (e.g., shift side-to-side). The circuit board includes one or more touch sensors that are each configured to detect a touch input on the cover layer. The circuit board also includes one or more force sensors that are each configured to detect a force input in response to movement of the cover layer along the first axis (e.g., normal to the surface of the cover layer). Additionally, the circuit board includes an actuator that is configured to translate the cover layer along one or more axes. For example, the cover layer can move along a first axis and/or along a second axis (e.g., in the plane of the surface of the cover layer) to produce a haptic output. The haptic output (e.g., the translational movement) of the cover layer can be perceived by a user as haptic feedback.

In some embodiments, the actuator can be one or more haptic actuators, such as piezoelectric actuators, ultrasonic actuators, or piston actuators. Additionally or alternatively, some components of a haptic output device can be positioned on the support structure or plate while other components are disposed on the circuit board. For example, an electromagnetic actuator can be attached to the circuit board and a conductive plate affixed to the support structure or plate. The position of the actuator on the circuit board corresponds to the position of the conductive plate on the support structure. When the circuit board is attached to the support structure, the actuator is located adjacent to the conductive plate. Haptic output is produced by passing an alternating current through the electromagnetic actuator, which produces alternating magnetic fields. The alternating magnetic fields attract and repel the conductive plate to generate the haptic output and shift the cover layer vertically and/or laterally.

In another aspect, an input device that is operably connected to an electronic device can include an input surface configured to receive user inputs, such as a touch input, an input/output (I/O) board disposed below the input surface, and a suspension element positioned below the I/O board. The I/O board may include a touch sensor disposed in or on the I/O board, where the touch sensor is configured to sense a touch input on the input surface, a force sensor disposed on the I/O board and configured to sense an amount of force applied to the input surface, and a haptic output device disposed on the I/O board and configured to produce haptic output. The suspension element permits the input surface to move in a first direction based on a touch input and/or a force input. The suspension element further allows the input surface to move in the first direction and, optionally, in a second direction that is transverse to the first direction in response to the haptic output produced by the haptic output device.

In another aspect, an electronic device includes a housing, a keyboard extending through at least one opening formed in the housing, and a trackpad positioned along a side of the keyboard. The trackpad includes a cover layer, a touch-sensitive layer positioned below the cover layer, a circuit layer positioned below the touch-sensitive layer, and a support structure positioned below the circuit layer. The support structure is formed as a recessed section of the housing. The support structure and the housing are a monolithic or indivisible element that is formed at the same time. The support structure includes an array of flexures that are configured to facilitate a displacement of the cover layer in response to an applied force, and to facilitate a lateral shift of the cover layer in response to a haptic output device.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows an example electronic device that includes a trackpad;

FIGS. 2 and 3 show exploded views of a trackpad that is suitable for use as the trackpad shown in FIG. 1;

FIG. 4 shows the interface module shown in FIGS. 2 and 3 when the circuit board is attached to the support structure;

FIG. 5 shows a cross-sectional view of an electronic device that includes the trackpad shown in FIGS. 2-4;

FIG. 6 shows another example of a support structure that is suitable for use in the trackpad shown in FIG. 1;

FIG. 7 shows an exploded view of an interface module that includes the support structure shown in FIG. 6;

FIG. 8 shows an exploded view of another trackpad that is suitable for use as the trackpad shown in FIG. 1; and

FIG. 9 shows a cross-section of one example of a trackpad that is suitable for use as the trackpad shown in FIG. 1.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to an input device, such as a trackpad, that can detect touch and/or force inputs and provide haptic feedback to a user as the user interacts with the trackpad. Some embodiments described herein are directed to a trackpad that is less complex and has fewer structural components than some conventional trackpads, which may reduce the cost and simplify manufacturing. For example, in some embodiments an interface module includes a single circuit board that is attached to the housing of the input device. In particular, the housing includes a recessed section that forms, and/or acts as, a support structure or plate; the circuit board is positioned in the recessed section and attached to the support structure. The recessed section, the support structure, and the housing can be formed in the same operation (e.g., at the same time and with the same material or materials). For example, in one embodiment, the recessed section, the support structure, and top surface are formed with aluminum. For example, in some embodiments, the support plate is an indivisible part of the top case of the housing of an electronic device.

The interface module includes the components that support and allow an input surface to move in response to user inputs (e.g., touch and/or force inputs), and to move based on haptic output produced by one or more haptic actuators or haptic output devices included in the interface module. The components in the interface module permit a user to interface or interact with an electronic device.

Some example embodiments are directed to a trackpad that includes a cover layer coupled to a circuit layer or circuit board. The cover layer and circuit board may be suspended by a support structure that is attached to, or integrally formed with, the housing of the electronic device. The support structure may include one or more suspension elements that provide at least two degrees of freedom allowing the cover layer to displace along one axis in response to an applied force and translate along one axis and/or a different axis (or axes) to provide a haptic or tactile feedback to the user. The dual-action suspension elements allow for a simplified and efficient design that may provide cost and manufacturing benefits.

Suspension elements can be formed by one or more flexures or flexible structures formed in the support structure. As used herein, the term “flexure” may refer to a structure that is configured to elastically deform in response to an applied force. The structure may include one or more features, such as a flexible member, beam, armature or other similar element that is configured to flex or bend in response to the applied force.

In other embodiments, the suspension elements are formed from a compressible layer that provides two or more degrees of freedom. The compressible layer may include a foam or other compressible, deformable, and/or compliant material that is configured to elastically compress or deform (allowing the cover layer to displace) and also to elastically shear or translate (allowing the cover layer to shift or move in a lateral direction).

The suspension elements permit the cover layer or input surface to move along multiple axes and may facilitate the trackpad functionality incorporated into the circuit board. For example, suspension elements may be configured to allow movement of the cover layer along a first axis that is perpendicular to the top surface and allow the cover layer to displace in response to a force or touch. Additionally, the suspension elements may be configured to allow the cover layer to move along a second and/or a third axis parallel with the top surface of the cover layer to allow the cover layer to shift or move in a lateral direction. This movement may facilitate a haptic output or response produced by a haptic output device, which may be perceived (tactically) by the user as haptic feedback. The cover layer may move along the first, second, and/or third axis as a user interacts with the trackpad and/or the electronic device (e.g., a software program displayed on a display screen of the electronic device).

The circuit board in the interface module is used to integrate multiple electrical sensors, electrical elements, and electromechanical sub-systems associated with the trackpad. By integrating all of these aspects on a single board, the design may be simplified, cost may be reduced, and the manufacturing assembly may be improved. In some implementations, the circuit board includes touch sensors configured to detect one or more touches on a cover layer or input surface positioned over the support structure. Additionally or alternatively, the circuit board may include one or more force sensors configured to sense one or more force inputs applied to the cover layer. Thus, the circuit board is an input/output (I/O) board that senses one or more different types of user inputs (touch, force). Additionally or alternatively, the I/O or circuit board can also include one or more haptic output devices that provide haptic output in response to some or all of the types of user inputs.

In some embodiments, the interface module includes an electromagnetic actuator that is attached to the circuit layer and a conductive plate that is attached to the support plate adjacent the electromagnetic actuator. The electromagnetic actuator is configured to produce varying magnetic fields that attract and repel the conductive plate to cause the input surface to translate horizontally (e.g., along an axis parallel with the top surface of the input surface). The translational movement of the input surface provides haptic feedback to a user as the user interacts with the trackpad and/or the electronic device (e.g., a software program displayed on a display screen of the electronic device).

Other embodiments can position the electromagnetic actuator and the conductive plate on different components within the electronic device. For example, in some embodiments, the electromagnetic actuator can be attached to the support plate and a conductive plate may be attached to the circuit board adjacent the electromagnetic actuator.

Although the described embodiments are directed to a trackpad in a notebook computer system, the present invention can be used with other types of input devices and/or other types of electronic devices. Input devices such as a cursor controller (e.g., a mouse), a keyboard, a button, a display, or an input region of a housing or enclosure can employ aspects of the present invention. Additionally or alternatively, other types of electronic devices include, but are not limited to, a remote control, a kiosk, an individually separate and distinct touchpad and/or keyboard operably connected to an electronic device, a smart phone, a tablet computing device, a digital media player, and a gaming device.

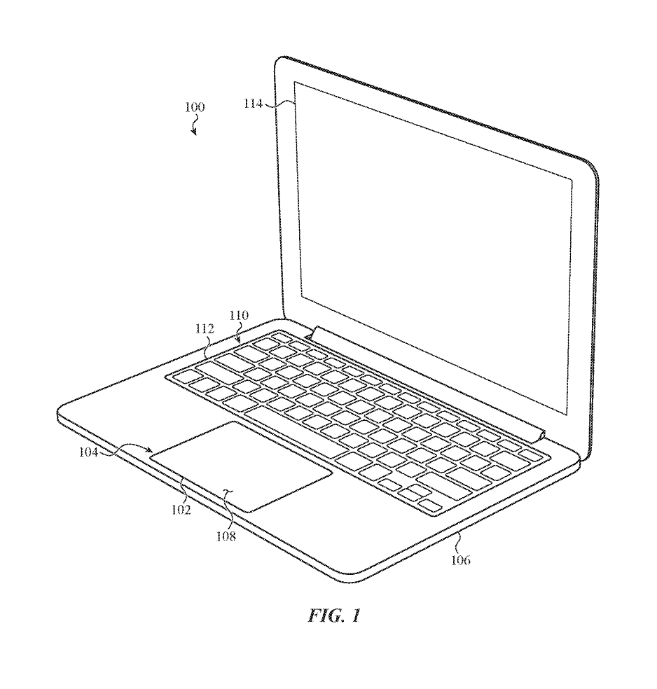

These and other embodiments are discussed below with reference to FIGS. 1-9. However, those skilled in the art will readily appreciate that the detailed description given herein with respect to these Figures is for explanatory purposes only and should not be construed as limiting.

FIG. 1 shows an electronic device 100 that incorporates a trackpad. The electronic device 100 is depicted as a portable notebook computer, although this is not required. A trackpad 102 is disposed in a recessed section 104 of the housing 106 of the electronic device 100. The trackpad 102 includes an interface module positioned below a cover layer 108. As will be described in more detail later, the interface module can include one or more touch sensors, one or more force sensors, and/or one or more haptic output devices. The trackpad 102 can be constructed with minimal components that receive touch and/or force inputs applied to the cover layer 108 as well as apply haptic output to the cover layer 108 as a user interacts with the trackpad 102.

The cover layer 108 acts as an input surface for the trackpad 102. The cover layer 108 may be formed with any suitable material or materials, including glass or plastic. In some embodiments, at least a portion of the cover layer 108 and/or the trackpad 102 can depress or deflect when a user presses or applies a force to the cover layer 108. For example, a user may depress or deflect a portion of the trackpad 102 to perform a “click” or a “double click” that selects an icon displayed on the display 114. Additionally or alternatively, in some embodiments a user can apply a force to the trackpad 102 to submit a force input for an application or function.

In some embodiments, haptic output is provided to the cover layer 108 in response to the user interaction with the trackpad 102. For example, haptic output can be applied to the cover layer 108 based on a touch and/or force input. The haptic output can indicate to the user that the force or touch input was received by the electronic device 100. For example, haptic output may be provided to the cover layer 108 after a user enters an input into an application program executed by a processing device in the electronic device 100.

For example, the haptic output may be a force, movement, and/or a vibration that may be detected by a user as haptic feedback. The haptic output can translate or lateral shift the cover layer 108 (movement along a first axis) and/or displace the cover layer 108 (movement along a second axis.

In the illustrated embodiment, the electronic device 100 also includes a keyboard 110 positioned adjacent to the trackpad 102. Like the trackpad 102, the keyboard 110 is disposed in an aperture 112 defined in the housing 106. In other embodiments, the keys of the keyboard 110 extend through discrete apertures formed in the housing 106. The keyboard 110 allows a user to interact with applications and programs running on the electronic device 100.

A display 114 provides a visual output to the user. The display 114 can be implemented with any suitable technology, including, but not limited to, a multi-touch sensing touchscreen that uses a liquid crystal display (LCD) element, a light emitting diode (LED) element, an organic light-emitting display (OLED) element, an organic electroluminescence (OEL) element, or another type of display element. In some embodiments, the display 114 can function as an input device that allows the user to interact with the electronic device 100. For example, the display 114 can be a multi-touch touchscreen display.

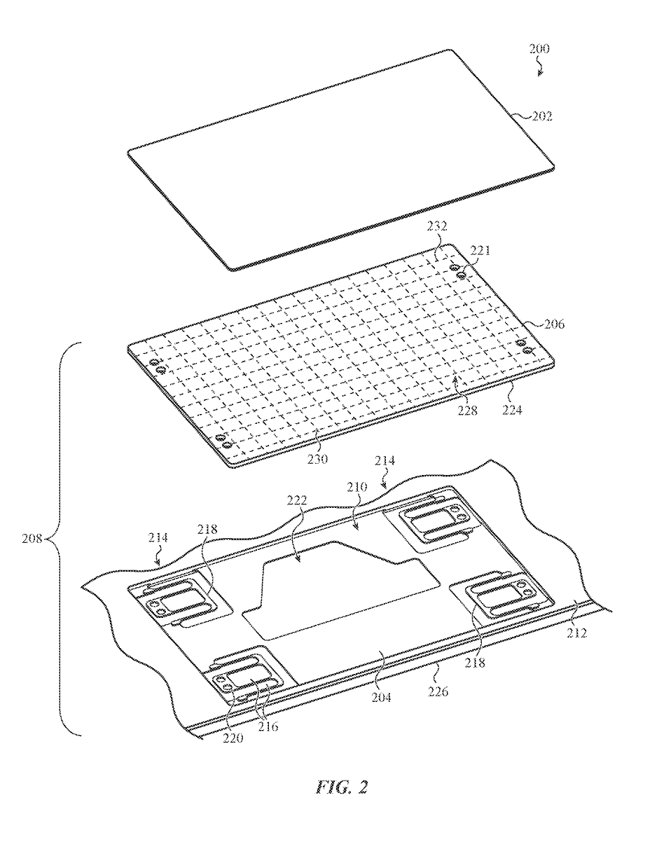

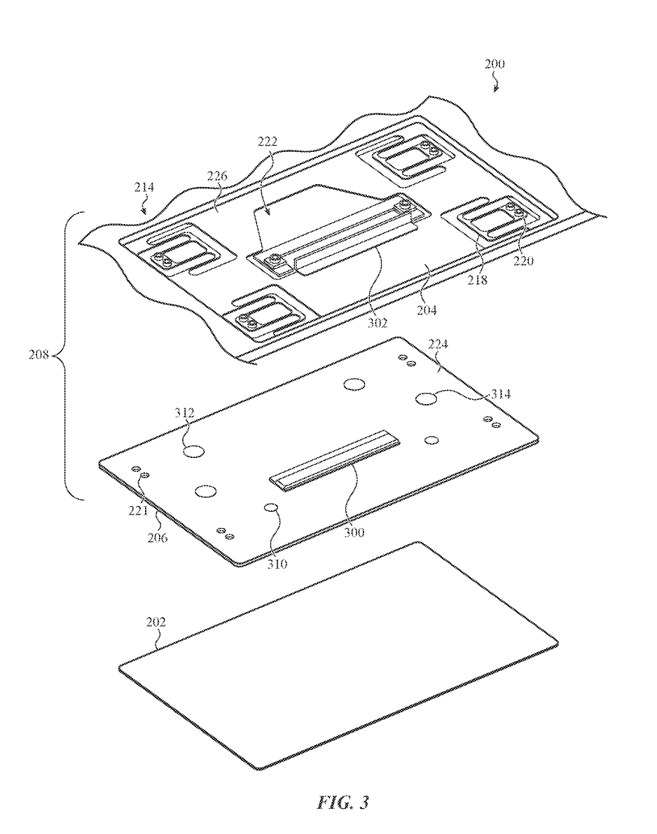

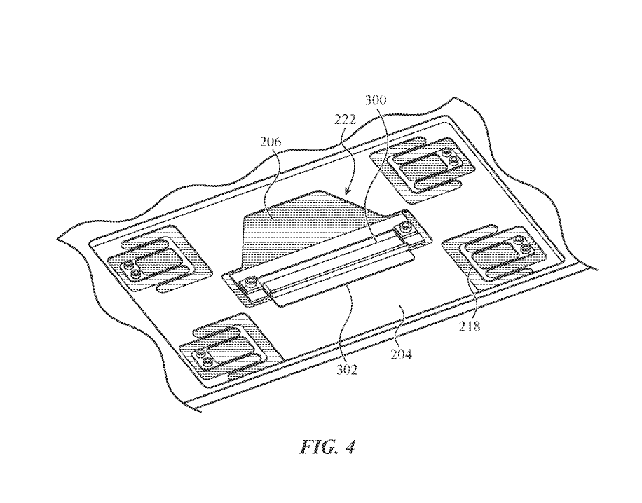

FIGS. 2 and 3 show exploded views of a trackpad that is suitable for use as the trackpad shown in FIG. 1. FIG. 2 illustrates the components of the trackpad as constructed (top surfaces of the components), while FIG. 3 depicts an inverted arrangement of the components (bottom surfaces of the components). FIG. 4 shows the interface module shown in FIGS. 2 and 3 when the circuit board is attached to the support structure. With respect to FIGS. 2-4, the trackpad 200 includes an input surface or cover layer 202, a support plate or support structure 204, and a circuit layer or circuit board 206 positioned between the cover layer 202 and the support structure 204. Together the circuit board 206 and the support structure 204 form an interface module 208.

The circuit board 206 is attached to the support structure 204 and to the cover layer 202. In some embodiments, a recessed section 210 is formed (i.e., machined) as part of a top surface 212 of the housing of the electronic device (e.g., the top surface of the housing 106 in FIG. 1). In such embodiments, the top surface 212 of the housing supports the circuit board 206 and the cover layer 202. The support structure 204 is the bottom surface of the recessed section 210. In other words, the recessed section 210, the support structure 204, and the top surface 212 may be formed as a single unitary and indivisible structure. The recessed section 210, the support structure 204, and top surface 212 may be formed with the same material and at the same time using, for example a casting, molding, machining, or other manufacturing process. The recessed section 210, the support structure 204, and top surface 212 may be formed from a metal, such as steel or aluminum, or a non-metal, such as a plastic or composite.

In some embodiments, the support structure 204 may be formed as a separate component. For example, the support structure 204 may be attached or affixed to an interior surface of the housing using any suitable fastener or fasteners. With reference to FIG. 1, the support structure 204 may be attached to an interior top surface of the housing 106. Example fastener(s) include, but are not limited to, screws, nuts and bolts, magnets, snap fasteners, solder, an adhesive, and combinations thereof.

The support structure 204 includes suspension elements 214 formed in (e.g., machined) the support structure 204. Four suspension elements 214 are depicted in FIGS. 2 and 3, although this is not required. The support structure 204 can include any number of suspension elements 214. In some embodiments, each of the suspension elements may be positioned at the corner of the circuit layer.

Each suspension element 214 includes apertures or cutouts 216 that create a flexure 218. As described earlier, a flexure is a structure that is configured to elastically deform in response to an applied force. The structure may include one or more features, such as a flexible member, beam, armature or other similar element that is configured to flex or bend in response to the applied force.

The suspension elements 214 or flexures 218 allow the cover layer 202 to move along one or more axes (e.g., up and down and/or side-to-side). In particular, the cover layer 202 is positioned over a top surface of the circuit board 206 and the bottom surface of the circuit board 206 is attached to the support structure 204. When attached, the circuit board 206 contacts the suspension elements 214. The flexures 218 support the circuit board 206 and the cover layer 202 and allow the circuit board 206 and the cover layer 202 to displace (movement along a first axis perpendicular to the top surface of the cover layer 202). Additionally, the flexures 218 permit the cover layer 202 to shift laterally (movement along at least a second axis that is parallel to the top surface of the cover layer 202).

The flexures 218 and the circuit board 206 include openings 220, 221 that are configured to receive fasteners to couple the circuit board 206 to the support structure 204. Any suitable type of fastener or combination of fasteners may be used. For example, the fastener(s) may be screws, nuts and bolts, magnets, snap fasteners, solder, an adhesive, or combinations thereof.

In some embodiments, an aperture 222 is formed (e.g., machined) in the support structure 204. The aperture 222 permits one or more components that are attached to the bottom surface 224 of the circuit board 206 to be accessible and/or to cooperatively operate with one or more components affixed to the bottom surface 226 of the support structure 204. For example, as will be discussed in conjunction with FIGS. 3 and 4, a haptic output device can be configured to have an actuator 300 attached to the bottom surface 224 of the circuit board 206 and a conductive plate 302 affixed to the bottom surface 226 of the support structure 204.

In some embodiments, the interface module 208 includes one or more touch sensors 228 configured to detect one or more touch inputs on the cover layer 202, one or more force sensors 310, 312 (FIG. 3) configured to detect one or more force inputs on the cover layer 202, and/or one or more haptic output devices 314 configured to cause the cover layer 202 to move or translate based on the haptic output produced by the one or more haptic output devices. The movement caused by the haptic output may be perceived by a user as haptic feedback.

Any suitable touch sensor 228 may be used. For example, in one embodiment, the circuit board 206 includes a first set of conductive traces 230 and a second set of conductive traces 232. The first set of conductive traces 230 is arranged along a first dimension of the circuit board 206 (e.g., width) and the second set of conductive traces 232 is arranged along a second dimension of the circuit board 206 (e.g., length). Capacitive sensors are formed at the intersections of the first and second sets of conductive traces 230, 232. The capacitive sensors collectively form a touch sensor 228 that detects one or more touch inputs (and the locations of the touch inputs) on the cover layer 202 through capacitive changes in the capacitive sensors. When a user touches the cover layer 202, the conductive traces 230, 232 move closer together at a location corresponding to the location of the touch or force input, which changes the capacitance of the corresponding capacitive sensor(s) (e.g., corresponding intersection(s)). The capacitive changes can be measured and correlated to the location of the touch input. In some embodiments, the conductive traces in the first set of conductive traces 230 can be electrically isolated from the conductive traces in the second set of conductive traces 232 by an interposing insulating or dielectric material.

Additionally or alternatively, a different type of touch sensor 228 can be used to detect touch inputs on the cover layer 202. For example, an ultrasonic sensor, a resistive sensor, and/or a strain gauge may be used.

Similarly, any suitable force sensor 310, 312 can be used. For example, in some embodiments, the force sensors 310, 312 are each implemented as one or more displacement sensors that detect a displacement between the force sensor (e.g., force sensor 310) and a surface in the trackpad 200 or a surface in the interface module 208. In some embodiments, the magnitude or amount of applied force can be estimated based on the determined amount of displacement and the known spring force/mechanical response of the suspension elements 214, the flexures 218, and/or the support structure 204.

For example, in one embodiment, a displacement sensor detects a displacement between the cover layer 202 and the circuit board 206. Additionally or alternatively, the one or more displacement sensors can detect a displacement between the support structure 204 and the circuit board 206. Additionally or alternatively, the one or more displacement sensors may detect a displacement between the circuit board 206 and a surface in the electronic device 100. For example, a displacement sensor may detect a displacement between the circuit board 206 and a bottom interior surface of the housing 106 of the electronic device 100.

One example of a displacement sensor is an optical sensor. The optical sensor can include a light emitter and a light detector. The light emitter is positioned to emit light toward a reflective surface in the trackpad, the interface module, or the housing of the electronic device. The light detector is positioned to detect the light that is reflected from the reflective surface. The distance between the optical sensor and the reflective surface can be derived from the amount of light detected by the light detector.

Another example of a displacement sensor is an eddy current sensor. An eddy current sensor operates with a magnetic field. An alternating current passes through an inductor or conductive coil, which creates a first magnetic field. A conductive surface or component within the first magnetic field produces an opposite second magnetic field that superimposes with the first magnetic field. The interaction between the first and second magnetic fields changes the impedance of the conductive coil. The impedance change depends on the distance between the conductive coil and the conductive surface or component. Accordingly, the distance between the conductive coil and the conductive surface or component can be derived by measuring the impedance change.

In the illustrated embodiment, the signals produced by the displacement sensors represent the distance between the circuit board 206 and the support structure 204. Using the spring force/mechanical response of the suspension elements 214, the flexures 218, and/or the support structure 204, a processing device can correlate the displacement signals to an amount of applied force.

Additionally or alternatively, different types of force sensors can be used in other embodiments. The trackpad 200 can include one or more resistive sensors, capacitive sensors, Hall Effect sensors, strain gauges, and/or ultrasonic sensors. The force sensors can be positioned at any suitable locations in the trackpad 200 and/or on the circuit board 206.

In some embodiments, a force-sensitive gasket can be included in the trackpad 200. For example, in one embodiment, the force-sensitive gasket can be positioned between the cover layer 202 and the circuit board 206. The force-sensitive gasket may be a continuous uninterrupted gasket that extends along a perimeter of the cover layer 202. Alternatively, the force-sensitive gasket may be formed from discrete segments; these segments or elements may or may not abut one another. In a non-limiting example, the force-sensitive gasket can be a capacitive force-sensitive gasket that is formed with two conductive layers separated by air or a compliant or deformable dielectric material.

For example, in some embodiments, a force sensor can be a capacitive sensor. In the illustrated embodiment, one or more capacitive sensors can be formed by conductive element(s) or electrode(s) (e.g., 310) on the circuit board 206 and the top surface of the support structure 204. Each electrode acts as a first plate of a capacitor and the surface of the support structure 204 as a second plate of the capacitor. When a force is applied to the cover layer 202, at least one electrode moves closer to the support structure 204, which changes the capacitance of the capacitor. The change in capacitance can be correlated to a magnitude or amount of force that was applied to the cover layer 202.

Additionally or alternatively, a force sensor (e.g., 312) can be a strain-sensitive element, such as a strain gauge. For example, in the illustrated embodiment, one or more strain-sensitive elements can be formed on the circuit board 206. When a force is applied to the cover layer 202, at least one strain-sensitive element experiences strain, which causes the strain-sensitive element(s) to deform. An electrical property (e.g., resistance) of the strain-sensitive element(s) changes based on the deformation. The change in the resistance can be measured and correlated to a magnitude or amount of force that was applied to the cover layer 202.

Additionally or alternatively, the circuit board 206 can include one or more haptic output device(s) 314 that produce a haptic output based on user interactions with the cover layer 202 (e.g., touch and/or force inputs) and/or the electronic device 100. Each haptic output device 314 may generate movement, a force, and/or vibrations that transfer to the cover layer 202. A user can detect the movement, force, and/or vibrations on the cover layer 202 and perceive the movement, force, and/or vibrations as haptic feedback.

For example, a user may touch the cover layer 202 to move a pointing device (e.g., a cursor) around a graphical user interface displayed on a display (e.g., display 114 in FIG. 1). Additionally or alternatively, a user can apply a force (e.g., a downward press) to the cover layer 202 to select an icon displayed in the graphical user interface, or to enter a force input to an application program (e.g., a game application). The one or more haptic output devices 314 can produce one or more haptic outputs that a user perceives as haptic feedback when the user's finger (or fingers) is in contact with the cover layer 202. The haptic feedback can indicate to the user that the touch or force input has been received by the application program or electronic device.

Additionally or alternatively, the haptic device(s) 314 may produce one or more haptic outputs based on a status of the electronic device and/or based on an application program. For example, haptic output can be created in response to an event or action that occurs in an application program (e.g., a game program). In another example, haptic output may be produced when the electronic device enters a low power state (e.g., a sleep state), enters a high power state (e.g., wakes up from a sleep state), and/or when an amount of charge on a battery reaches a given level.

One example of a haptic output device 314 is a piezoelectric actuator. A piezoelectric actuator includes a piezoelectric material that converts an electrical signal into motion or vibrations. Other examples of a haptic output device 314 include, but are not limited to, an ultrasonic actuator, an electromagnetic actuator, and a piston actuator.

In some embodiments, a haptic output device includes the electromagnetic actuator 300 that is attached to the bottom surface 224 of the circuit board 206 and the conductive plate 302 affixed to the bottom surface 226 of the support structure 204. The position of the actuator 300 on the circuit board 206 corresponds to the aperture 222 and to the position of the conductive plate 302 on the support structure 204 (see also FIG. 4). When the circuit board 206 is attached to the support structure 204, the actuator 300 is located within (extends into) the aperture 222 adjacent to the conductive plate 302 (see also FIG. 4). The actuator 300 is configured as an electromagnetic actuator with a housing that supports one or more coils. When haptic output is to be produced, an alternating current passes through the coil(s), which produces alternating magnetic fields. The alternating magnetic fields attract and repel the conductive plate 302 to generate the haptic output.

Other embodiments can position the electromagnetic actuator and the conductive plate on different components within the electronic device. For example, in some embodiments, the electromagnetic actuator can be attached to the support plate and a conductive plate may be attached to the circuit board adjacent the electromagnetic actuator.

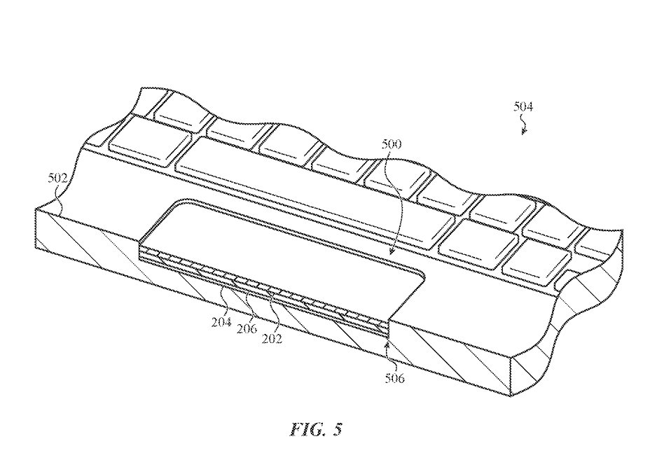

FIG. 5 shows a cross-sectional view of an electronic device that includes the trackpad shown in FIGS. 2-4. As described earlier, the support structure 204 can be the bottom surface of a recessed section 506 of the housing 502. The support structure 204 and the housing 502 are a monolithic and/or unitary structure that may be formed in a single operation (e.g., at the same time with the same material(s)), although in some embodiments multiple operations may occur to form the support structure and housing. The circuit board 206 is positioned over the support structure 204, and the input surface or cover layer 202 is positioned over the circuit board 206. Accordingly, the housing 502 (via the support structure 506) supports the circuit board 206 and the cover layer 202.

The cover layer 202 is accessible to a user through an aperture 500 defined in the housing 502 of the electronic device 504. The cover layer 202 can be made of any suitable material, such as glass or plastic. In some embodiments, the cover layer 202 is formed with multiple layers, including a transparent top layer that a user touches and an opaque layer positioned below the top layer. The opaque layer can conceal or hide the other components in the trackpad from the user's view.

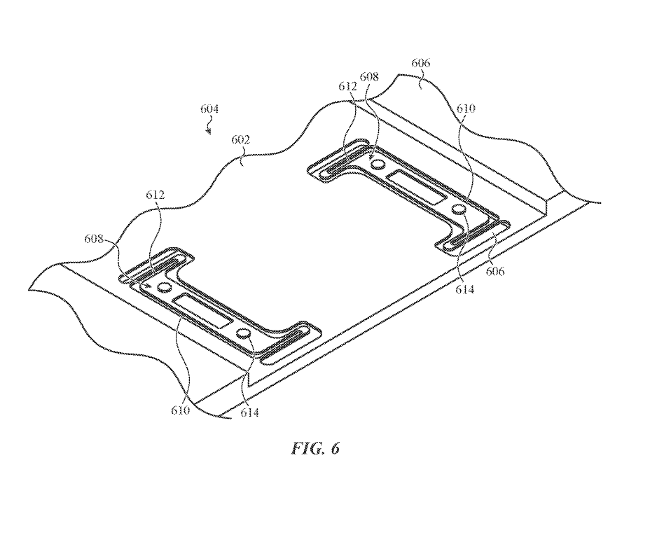

FIG. 6 shows another example of a support structure that is suitable for use in the trackpad shown in FIG. 1. FIG. 6 depicts a top surface 602 of the support structure 600. In some embodiments, the support structure 600 is the bottom surface of a recessed section 604 of a housing 606. In other embodiments, the support structure 600 can be attached to a surface of the housing 606.

The support structure 600 includes suspension elements 608 formed or machined in the support structure 600. Although only two suspension elements 608 are depicted in FIG. 6, this is not required. The support structure 600 can include any number of suspension elements 608. The suspension elements 608 allow a cover layer to move with respect to the support structure 600. In particular, the suspension elements 608 permit the cover layer to be displaced (e.g., move in a first direction or along a first axis) as well as to shift laterally (e.g., move along a second axis or move one or more directions that are transverse to the first direction).

In the illustrated embodiment, each suspension element 608 includes apertures or cutouts 610 that create a flexure 612. Each flexure is a structure that is configured to elastically deform in response to an applied force. For example, each flexure can be a flexible member, beam, armature or other similar element that is configured to flex or bend in response to the applied force.

In some embodiments, the support structure 600 can further include protruding structures 614. The protruding structures 614 extend out from the surface of the flexures 612. The protruding structures 614 contact a circuit board. The protruding structures 614 can provide support for the circuit board as the circuit board moves up and down (e.g., is displaced). Although four protruding structures 614 are shown in FIG. 6, a support structure 600 can include any number of protruding structures 614.

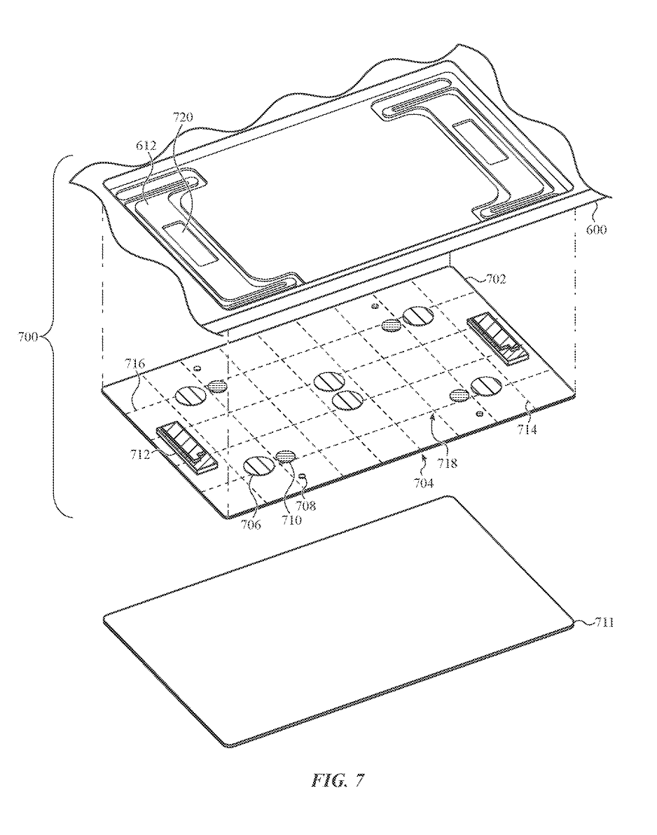

FIG. 7 shows an exploded view of an interface module that includes the support structure shown in FIG. 6. The interface module 700 includes the support structure 600 and a circuit board 702 that contacts and attaches to the top surface 602 of the support structure 600. The circuit board 702 can attach to the support structure 600 using any suitable fasteners. Example fasteners include screws, solder, adhesive, and combinations thereof.

The circuit board 702 can include a touch sensor 704, one or more force sensors 706, 708 and one or more haptic output devices 710, 712. The touch sensor 704 is configured to detect one or more touches (and the locations of the touches) on an input surface or cover layer 711. Any suitable touch sensor may be used. For example, in one embodiment, the circuit board 702 includes a first set of conductive traces 714 arranged along a first dimension of the circuit board 702 (e.g., width) and a second set of conductive traces 716 arranged along a second dimension of the circuit board 702 (e.g., length). Capacitive sensors are formed at the intersections 718 of the first and second sets of conductive traces 714, 716. The capacitive sensors collectively form a touch sensor that detects one or more touch inputs on the input surface or cover layer 711. The conductive traces in the first set of conductive traces 714 may be electrically isolated from the conductive traces in the second conductive traces 716 by an interposing insulating or dielectric material.

Additionally or alternatively, a different type of touch sensor can be used to detect touch inputs on the cover layer or input surface. For example, an ultrasonic sensor, a resistive sensor, and/or a strain gauge may be used.

The one or more force sensors 706, 708 can each be implemented with any suitable type of force sensor. For example, in the illustrated embodiment, the force sensors 706, 708 are configured as displacement sensors. The force sensors 706 are eddy current sensors and the force sensors 708 are optical sensors. As discussed earlier, eddy current sensors operate with magnetic fields. An alternating current passes through an inductor or conductive coil, which creates a first magnetic field. A conductive surface or component within the magnetic field produces an opposite second magnetic field that superimposes with the first magnetic field. In FIG. 7, the conductive surface is the top surface 602 of the support structure 600. The interactions between the first and second magnetic fields change the impedance of the conductive coil. The impedance change depends on the distance between the conductive coil and the top surface 602 of the support structure 600. Accordingly, the distance between the conductive coil and the top surface 602 of the support structure 600 can be derived by measuring the impedance change.

The one or more optical sensors each include a light emitter and a light detector. In the illustrated embodiment, the light emitter is positioned to emit light towards the top surface 602 of the support structure 600. The light detector is positioned to detect the light reflected from the top surface 602 of the support structure 600. The distance between each optical sensor and the support structure 600 can be derived from the amount of light detected by the light detector.

The displacement signals produced by the eddy current sensors and the optical sensors represent the distance between the circuit board 702 and the support structure 600. The displacement signals are correlated to an amount of force that is applied to the input surface or cover layer 711 and causes the flexures 612 to be displaced the measured distance. A processing device can correlate the displacement signals into an amount of force applied to the cover layer (e.g., cover layer 108 in FIG. 1).

As described earlier, different types of force sensors can be used in other embodiments. The interface module 700 can include one or more resistive sensors, capacitive sensors, Hall Effect sensors, ultrasonic sensors, and/or strain sensors. The force sensors can be positioned at any suitable locations in the interface module 700 and/or on the circuit board 702. Additionally or alternatively, in some embodiments, a force-sensitive gasket can be included in the interface module 700 and/or between the interface module 700 and the cover layer 711.

The one or more haptic output devices 710, 712 can each be implemented with any suitable haptic output device. For example, in the illustrated embodiment, the haptic output devices 710 are piezoelectric transducers that include a piezoelectric material that converts an electrical signal into motion or vibrations. The haptic output devices 712 can be inertia drive actuators. In the illustrated embodiment, the haptic output devices 712 extend into openings 720 formed in the flexures 612 of the support structure 600. Each inertia drive actuator includes a piezoelectric material that expands and contracts based on an alternating current applied to the piezoelectric material. This expansion and contraction moves a mass back and forth along a shaft or surface. Thus, the expansion and contraction of the piezoelectric material is translated into a back and forth linear motion of a mass. The back and forth motion of the inertia drive actuators moves the flexures 612, which in turn moves the cover layer 711.

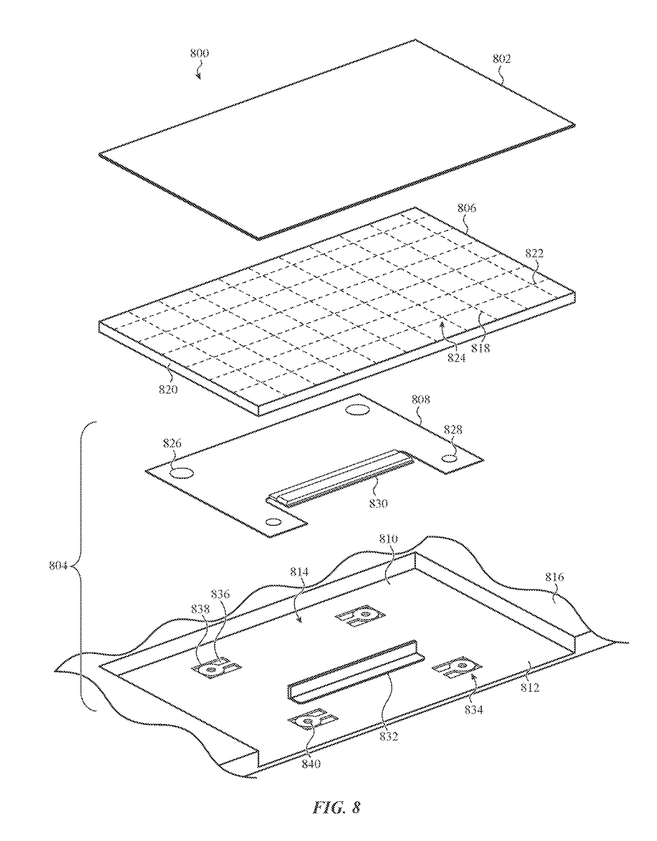

FIG. 8 shows an exploded view of another trackpad that is suitable for use as the trackpad shown in FIG. 1. The trackpad 800 includes an input surface or a cover layer 802, a touch-sensitive layer 806 positioned below the cover layer 802, and an interface module 804 positioned below the touch-sensitive layer 806. The touch-sensitive layer 806 is configured to detect touch inputs on the input surface or cover layer 802. In the illustrated embodiment, the interface module 804 includes a circuit or I/O board 808 and a support structure 810.

FIG. 8 depicts a top surface 812 of the support structure 810. In some embodiments, the support structure 810 is the bottom surface of a recessed section 814 of a housing 816. Thus, the support structure 810 and the housing 816 are one monolithic component. The recessed section 814, the support structure 810, and the housing 816 are formed at the same time and with the same material(s). For example, in one embodiment, the support structure 810 and the housing 816 are formed with a metal, such as aluminum. In other embodiments, the support structure 810 can be attached to a surface of the housing 816.

The touch-sensitive layer 806 can employ any suitable sensing technology, including, but not limited to, capacitive touch sensing, resistive touch sensing, and ultrasonic touch sensing. In FIG. 8, the touch-sensitive layer 806 is a capacitive touch-sensitive layer. Conductive traces in a first set of conductive traces 818 are arranged along a first dimension of a substrate 820 (e.g., width) and the conductive traces in a second set of conductive traces 822 are arranged along a second dimension of the substrate 820 (e.g., length). Capacitive sensors are formed at the intersections 824 of the first and second sets of conductive traces 818, 822. The capacitive sensors collectively form a touch sensor that detects one or more touch inputs (and the locations of the touch inputs) on the cover layer 802. The conductive traces in the first set of conductive traces 818 can be electrically isolated from the conductive traces in the second conductive traces 822 by an interposing insulating or dielectric material.

The I/O or circuit board 808 can include one or more force sensors 826, 828. In one embodiment, the force sensors 826, 828 can be different types of force sensors. In other embodiments, the force sensors 826, 828 can be the same type of force sensors. Any suitable type of force sensor(s) can be used. Example force sensors include, but are not limited to, eddy current sensors, optical sensors, strain gauges, and/or ultrasonic sensors.

In some embodiments, a haptic output device includes an electromagnetic actuator 830 attached to the circuit board 808 and a conductive plate 832 affixed to the support plate or structure 810. The position of the electromagnetic actuator 830 on the I/O or circuit board 808 corresponds to the position of the conductive plate 832 on the support structure 810. When the I/O or circuit board 808 and the support structure 810 are attached to one another, the electromagnetic actuator 830 is located adjacent to the conductive plate 832. When haptic output is to be produced, an alternating current passes through the electromagnetic actuator 830, which produces alternating magnetic fields. The alternating magnetic fields attract and repel the conductive plate 832 to generate the haptic output.

The support structure 810 includes suspension elements 834 formed or machined in the support structure 810. Four suspension elements 834 are depicted in FIG. 8, although this is not required. The support structure 810 can include any number of suspension elements 834.

Each suspension element 834 includes apertures or cutouts 836 that create a flexure 838. The suspension elements 834 allow the cover layer 802 to move with respect to the support structure 810. In particular, the flexures 838 permit the cover layer 802 to move vertically and/or horizontally with respect to the support structure 810.

Openings 840 are formed in each flexure 838. The openings 840 are configured to receive fasteners that are used to couple the circuit board 808 to the support structure 810. Any suitable type of fastener(s) can be used. Example fastener(s) include, but are not limited to, screws, nuts and bolts, magnets, snap fasteners, solder, an adhesive, and combinations thereof.

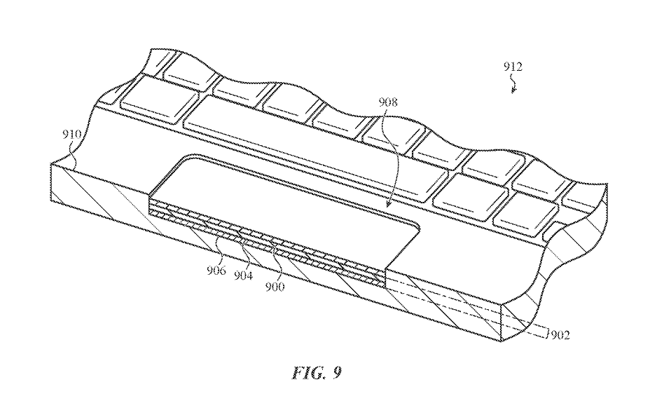

FIG. 9 shows a cross-section of a third example of a trackpad that is suitable for use as the trackpad shown in FIG. 1. The trackpad includes a cover layer 900 and an interface module 902 positioned below the cover layer 900. The interface module 902 includes a circuit or I/O board 904 and a deformable or compressible layer 906 positioned below the circuit board 904. The cover layer 900 is positioned in recessed section 908 of the housing 910 of the electronic device 912.

The I/O or circuit board 904 can include one or more touch sensors, one or more force sensors, and/or one or more haptic output devices. For example, in one embodiment the circuit board 904 is configured as the circuit board shown in FIG. 7.

The compressible layer 906 acts as a suspension element, in that the compressible layer 906 allows the cover layer 900 to be displaced as well as to translate or shift laterally. The compressible layer 906 deforms in response to touch or force inputs applied to the cover layer 900, which causes the cover layer 900 to be displaced (e.g., move up and down). Additionally, the compressible layer 906 permits the cover layer 900 to be displaced and/or to shift laterally in response to haptic output produced by one or more haptic actuators or output devices on the circuit board 904. The compressible layer 906 can be formed with any suitable material or materials. For example, in one embodiment, the compressible or deformable layer 906 is a layer of foam.

Although the embodiments disclosed herein include a touch sensor in the I/O board or as a separate component in an interface module, other embodiments are not limited to these constructions. In some embodiments, a cover layer can include multiple layers with the touch sensor included in one of the multiple layers.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. An electronic device, comprising:
a housing defining a support structure; and
a trackpad positioned in the support structure and comprising:
a cover layer configured to receive a touch input; and
a circuit board positioned below the cover layer;
wherein:
the support structure is positioned within a recessed section of the housing;
the support structure includes suspension elements that are configured to permit movement of the cover layer; and
the circuit board comprises:
a touch sensor configured to detect the touch input on the cover layer;
a force sensor configured to detect a force input in response to movement of the cover layer; and
an actuator configured to translate the cover layer to produce a haptic output.

2. The electronic device of claim 1, wherein the support structure is unitary with the housing.

3. The electronic device of claim 1, wherein:
the actuator comprises an electromagnetic actuator attached to the circuit board and extending into an aperture in the support structure;
the electromagnetic actuator is positioned adjacent a conductive plate attached to the support structure; and
the electromagnetic actuator is configured to produce varying magnetic fields that attract and repel the conductive plate to translate the cover layer along a first axis and a second axis.

4. The electronic device of claim 1, wherein:
each of the suspension elements includes a flexure integrally formed into the support structure; and
the flexure is configured to flex along a first axis and a second axis.

5. The electronic device of claim 1, wherein the force sensor comprises a displacement sensor configured to detect a displacement of the cover layer and the circuit board.

6. The electronic device of claim 5, wherein the displacement sensor comprises at least one of:
an optical sensor; or
an eddy current sensor.

7. The electronic device of claim 1, wherein the touch sensor comprises a capacitive touch sensor formed from intersecting conductive traces.

8. An input device operably connected to an electronic device, the input device comprising:
an input surface configured to receive a touch input;
an input/output (I/O) board disposed below the input surface, the I/O board comprising:
a touch sensor disposed in or on the I/O board and configured to sense the touch input on the input surface;
a force sensor disposed on the I/O board and configured to sense an amount of force applied to the input surface; and
a haptic output device disposed on the I/O board and configured to produce haptic output; and
a suspension element formed as part of a recessed section of a housing associated with the input device and positioned below the I/O board and configured to allow the input surface to:
move in a first direction in response to a force input; and
move in the first direction and in a second direction, transverse to the first direction, in response to the haptic output produced by the haptic output device.

9. The input device of claim 8, wherein the input device forms a trackpad of a notebook computer system.

10. The input device of claim 8, wherein the suspension element comprises a compressible layer.

11. The input device of claim 8, wherein the touch sensor comprises intersecting traces formed in the I/O board.

12. The input device of claim 8, wherein the force sensor comprises a displacement sensor.

13. The input device of claim 8, wherein the haptic output device comprises a piezoelectric actuator.

14. An interface module for an input device, the interface module comprising:
a support plate integral with a housing of the input device;
flexures formed in the support plate, the flexures configured to permit a cover layer positioned over the interface module to move along a first axis and a second axis; and
a circuit board attached to the support plate and positioned between the support plate and the cover layer, the circuit board comprising:
an input sensor configured to sense user inputs applied to the cover layer, wherein the cover layer moves along the first axis based on the user inputs; and
a haptic output device configured to move the cover layer along a second axis to produce a haptic output.

15. The interface module of claim 14, wherein:
at least one user input comprises a force input; and
the input sensor comprises a force sensor configured to detect the force input.

16. The interface module of claim 15, wherein the force sensor is configured to detect a displacement of the support plate.

17. The interface module of claim 14, wherein:
at least one user input comprises a touch input; and
the input sensor is configured to detect the touch input on the cover layer.

18. The interface module of claim 14, wherein:
at least one user input comprises a touch input; and
the input sensor comprises a capacitive touch sensor configured to detect the touch input on the cover layer, the capacitive touch sensor comprising intersecting traces formed in the circuit board.

19. The interface module of claim 14, further comprising a touch-sensitive layer positioned between the cover layer and the interface module.

20. The interface module of claim 14, wherein each flexure is defined by cutouts in the support plate.

21. An electronic device, comprising:
a housing;
a keyboard extending through at least one opening formed in the housing; and
a trackpad positioned along a side of the keyboard and comprising:
a cover layer;
a touch-sensitive layer positioned below the cover layer;
a circuit layer positioned below the touch-sensitive layer; and
a support structure integral with the housing and positioned below the circuit layer, the support structure comprising an array of flexures that is configured to:
facilitate a first displacement of the cover layer in response to an applied force; and
facilitate a second displacement and a lateral shift of the cover layer in response to a haptic output device.

22. The electronic device of claim 21, wherein
the array of flexures is machined into the support structure.

23. The electronic device of claim 21, wherein the array of flexures comprises four flexures, each positioned proximate to a respective corner of the circuit layer.

24. The electronic device of claim 21, wherein:
the circuit layer includes a sensor for detecting the displacement of the cover layer; and
the circuit layer includes at least a portion of the haptic actuator.
